(19) United States
(12) Patent Application Publication
(10) Pub. No.: US 2026/0246855 A1
(43) Pub. Date: Aug. 20, 2026

(54) System and Method for Seamless Integration of Mesh Networking Protocols, Sub-Gigahertz Band Communication, and BLE Location Technologies for Enhanced IoT Connectivity and Localization

(71) Applicant: Silicon Laboratories Inc., Austin, TX (US)

(72) Inventors: Wael Guibene, McKinney, TX (US); Brent Corn, Allen, TX (US)

(21) Appl. No.: 19/055,707

(22) Filed: Feb. 18, 2025

(51) Int. Cl. H04L 69/08

(52) U.S. Cl. CPC H04L 69/08

(57) ABSTRACT

A comprehensive set of software modules and algorithms corresponding to the integration of multiple network protocols and location technologies is disclosed. The software modules supports three or more network protocols, including a mesh network protocol, the Bluetooth LE protocol and a sub-GHz band protocol. A plurality of different location detection algorithms are also supported. The selections of the appropriate network protocol and location detection algorithm are made based on a dynamic evaluation of various factors, such as device proximity, battery level, interference in the environment, bandwidth requirements and others.

### FIELD

This disclosure describes systems and methods for seamless transitions between various network protocols and location detection algorithms.

### BACKGROUND

There are various network protocols that are currently in use. Each serves a specific function. For example, Bluetooth is commonly used for device-to-device communications, such as a computer to a wireless mouse or keyboard, or a mobile phone to a wireless speaker and microphone. Bandwidth and range are somewhat limited for the Bluetooth protocol. Another common network protocol is WiFi. WiFi supports much higher data rates and also allows multiple devices on a shared network. Additionally, there are mesh networks, such as Thread, Zigbee and other protocols based on the IEEE 802.15.4 standard. These mesh networks allow multiple devices on a common network with simple routing protocols. Mesh networks may also support sleepy end devices, which are devices that enter sleep mode to conserve power. Additionally, there are sub-GHz band network protocols. Because of their lower frequency, these networks typically have much greater range. For example, sub-GHz band networks may include LoRa and frequency-shift keying at under 1 GHz.

A low-bandwidth long-range wireless communication, called Amazon Sidewalk, has also been developed. Amazon Sidewalk combines Bluetooth LE for short distance communications and sub-GHz communications for longer distances.

Switching between these different networks may be challenging, as there are many factors to consider, such as required range, estimated power consumption, signal interference in the environment, and others. Therefore, it would be advantageous if there were a system and method that allowed a network device to seamlessly switch between network protocols. Further, it would be beneficial if the network device was also able to switch between different location detection algorithms.

### SUMMARY

A comprehensive set of software modules and algorithms corresponding to the integration of multiple network protocols and location technologies is disclosed. The software modules supports three or more network protocols, including a mesh network protocol, the Bluetooth LE protocol and a sub-GHz band protocol. A plurality of different location detection algorithms are also supported. The selections of the appropriate network protocol and location detection algorithm are made based on a dynamic evaluation of various factors, such as device proximity, battery level, interference in the environment, bandwidth requirements and others.

According to one embodiment, a network device capable of operating using at least three different network protocols is disclosed. The network device comprises a network interface; a processing unit; and a memory device in communication with the processing unit, comprising instructions executable by the processing unit, the instructions comprising: a first network stack to support a first network protocol; a second network stack to support a second network protocol; a third network stack to support a third network protocol; a dynamic network selection module to select between the at least three network protocols; and a handoff module to manage a transition from one network protocol to another network protocol. In some embodiments, the dynamic network selection module receives one or more inputs and determines an appropriate network protocol based on the one or more inputs. In certain embodiments, the one or more inputs comprise one or more of proximity (P) to a nearest external anchor device, current battery level (B), bandwidth/latency requirements (W), measured or estimated interference from (I) environment or security requirements (Sec). In certain embodiments, the dynamic network selection module comprises a machine learning module that uses at least two of the one or more inputs to determine the appropriate network protocol. In certain embodiments, the machine learning module utilizes a decision function having weights associated with each network protocol and each of the at least two of the one or more inputs. In certain embodiments, the dynamic network selection module estimates a battery level based on a current battery level and power consumed by a current network protocol, and selects the appropriate network protocol based on the estimated battery level. In certain embodiments, the dynamic network selection module selects the appropriate network protocol based on whether the network device is located indoors or outdoors. In some embodiments, the first network protocol comprises Bluetooth LE, the second network protocol comprises a mesh network protocol and the third network protocol comprises a sub-GHz network protocol. In some embodiments, when a new network protocol is selected, the handoff module queries a newly selected network stack to establish parameters for a new link, performs security re-keying and authentication, and activates the new link and deactivates a current link.

According to another embodiment, a network device capable of utilizing at least two different location detection algorithms is disclosed. The network device comprises a network interface; a processing unit; and a memory device in communication with the processing unit, comprising instructions executable by the processing unit, the instructions comprising: a RSSI-based location algorithm; at least one angle of arrival (AoA)/angle of departure (AoD) based location algorithm; and a location detection algorithm selection module to select between the RSSI-based location algorithm and the at least one AoA/AOD based location algorithm. In some embodiments, one of the at least one AoA/AOD based location algorithm, referred to as a weighted AoA/AOD algorithm, uses RSSI information to assign a weight to various AoA/AOD measurements. In some embodiments, one of the at least one AoA/AOD based location algorithm, referred to as a hybrid angle distance (HAD) algorithm, uses AOA/AOD information and RSSI information from a plurality of external anchor devices to determine a distance and angle to each of the plurality of external anchor devices and uses the distance and angle to determine a location of the network device. In certain embodiments, the RSSI information is also used to assign a weight to information associated with each of the plurality of external anchor devices. In some embodiments, the location detection algorithm selection module selects a location detection algorithm based on whether the network device is located indoors or outdoors. In some embodiments, the location detection algorithm selection module estimates a battery level based on a current battery level and power consumed by a current network protocol, and selects a location detection algorithm based on an estimated battery level. In some embodiments, the location detection algorithm selection module selects a location detection algorithm based on whether there is a line of sight to at least one external anchor device. In some embodiments, the location detection algorithm selection module selects a location detection algorithm based on a network protocol currently being used by the network device.

According to another embodiment, a system that utilizes a mesh network is disclosed. The system comprises a plurality of network devices; and a network bridge; wherein each of the plurality of network devices maintains a routing table for reachable network devices in the mesh network; wherein if a packet is intended for a network device that is not in the routing table, the network device forwards the packet to the network bridge; and wherein the network bridge uses one or more inputs to determine whether to forward the packet using a sub-GHz network or Bluetooth LE. In some embodiments, the one or more inputs comprise proximity (P) to a nearest external anchor device, current battery level (B), bandwidth/latency requirements (W), measured or estimated interference (I) from environment or security requirements (Sec). In certain embodiments, the network bridge comprises a machine learning module that uses at least two of the one or more inputs to select the sub-GHz network or Bluetooth LE.

### BRIEF DESCRIPTION OF THE DRAWINGS

For a better understanding of the present disclosure, reference is made to the accompanying drawings, in which like elements are referenced with like numerals, and in which:

FIG. 1 shows a block diagram of a wireless network device according to one embodiment;

FIG. 2 shows a block diagram of the dynamic network selection software according to one embodiment;

FIG. 3 shows the operation of the machine learning model used to select the network of choice according to one embodiment;

FIG. 4 shows a block diagram of the location detection algorithm selection software according to one embodiment; and

FIG. 5 shows a block diagram of the routing software according to one embodiment.

### DETAILED DESCRIPTION

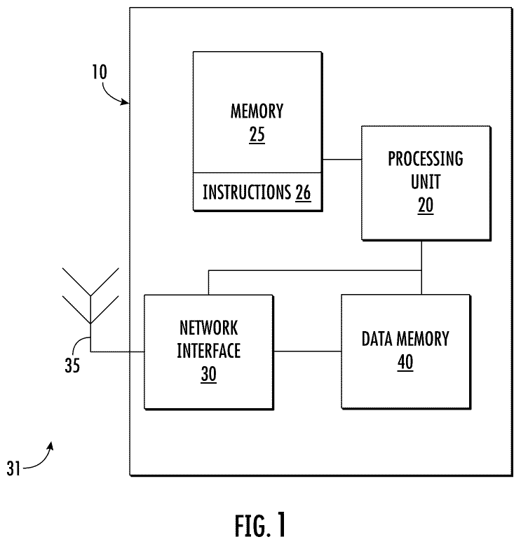

FIG. 1 shows a block diagram of a representative network device 10 that is able to seamlessly switch between network protocols and location detection algorithms.

The network device 10 has a processing unit 20 and an associated memory device 25. The processing unit 20 may be any suitable component, such as a microprocessor, embedded processor, an application specific circuit, a programmable circuit, a microcontroller, or another similar device. This memory device 25 contains the instructions 26, which, when executed by the processing unit 20, enable the network device 10 to perform the functions described herein. This memory device 25 may be a non-volatile memory, such as a FLASH ROM, an electrically erasable ROM or other suitable device. In other embodiments, the memory device 25 may be a volatile memory, such as a RAM or DRAM.

While a memory device 25 is disclosed, any computer readable medium may be employed to store these instructions. For example, read only memory (ROM), a random access memory (RAM), a magnetic storage device, such as a hard disk drive, or an optical storage device, such as a CD or DVD, may be employed. Furthermore, these instructions may be downloaded into the memory device 25, such as for example, over a network connection (not shown), via CD ROM, or by another mechanism. These instructions may be written in any programming language, which is not limited by this disclosure. Thus, in some embodiments, there may be multiple computer readable non-transitory media that contain the instructions described herein. The first computer readable non-transitory media may be in communication with the processing unit 20, as shown in FIG. 1. The second computer readable non-transitory media may be a CDROM, or a different memory device, which is located remote from the network device 10. The instructions contained on this second computer readable non-transitory media may be downloaded onto the memory device 25 to allow execution of the instructions by the network device 10.

The network device 10 also includes a network interface 30, which may be a wireless interface that connects with an antenna 35. The network interface 30 may support multiple wireless networks, such as Bluetooth, Bluetooth LE (BLE), Wi-Fi, networks utilizing the IEEE 802.15.4 specification, such as Zigbee, Thread and Wi-SUN, networks utilizing the IEEE 802.15.6 specification, sub-GHz band networks, such as LoRa, frequency-shift keying and others, and wireless smart home protocols, such as Z-Wave. Further, the network interface 30 may also support a proprietary or custom wireless network. The network interface 30 includes a transmit circuit which is used to transmit data from this network device 10 using the antenna 35. The network interface 30 also includes a receive circuit which is used to receive packets from any of the plurality of networks.

The network device 10 may include a data memory device 40 in which data that is received and transmitted by the network interface 30 is stored. This data memory device 40 is traditionally a volatile memory. The processing unit 20 has the ability to read and write the data memory device 40 so as to communicate with the other nodes in the wireless network 31. Although not shown, the network device 10 also has a power supply, which may be a battery or a connection to a permanent power source, such as a wall outlet.

While the processing unit 20, the memory device 25, the network interface 30, and the data memory device 40 are shown in FIG. 1 as separate components, it is understood that some or all of these components may be integrated into a single electronic component. Rather, FIG. 1 is used to illustrate the functionality of the network device 10, not its physical configuration. Further, the network device 10 may operate in a plurality of modes. Specifically, the network device is capable of operating using one of a plurality of network protocols and to seamlessly switch between these network protocols.

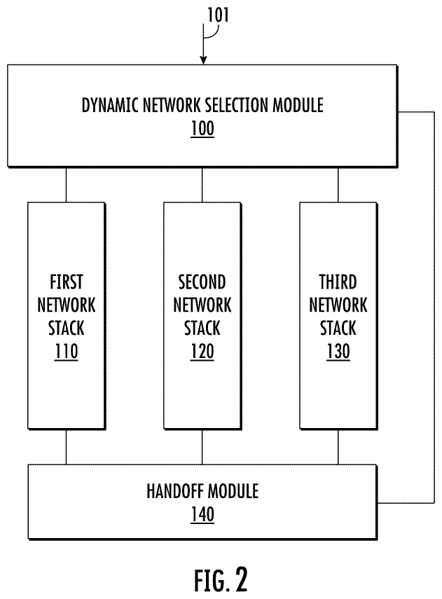

FIG. 2 shows the architecture of a portion of the software that makes up part of the instructions 26 located in the memory device 25. This portion of software, referred to as the dynamic network selection software, includes a dynamic network selection module 100, which is a set of instructions that allows the selection of an appropriate network protocol, as described in more detail below. Additionally, the dynamic network selection software includes at least three network stacks, a first network stack 110, a second network stack 120 and a third network stack 130. Each network stack includes the instructions necessary to configure the network interface 30 to transmit and receive packets using that specific network protocol.

The first network stack 110 may be associated with the Bluetooth LE network protocol. The second network stack 120 may be associated with a mesh network protocol, such as Thread, Zigbee or others. The third network stack 130 may be associated with a sub-GHz band network protocol, such as LoRa or frequency-shift keying at under 1 GHZ.

Additionally, there are a number of inputs 101 that are provided to the dynamic network selection module 100. These inputs 101 may include the proximity (P) to the nearest external anchor device (for location detection), the current battery level (B), the bandwidth/latency requirements (W) associated with the current communications, the measured or estimated interference (I) from the environment and the security requirements (Sec).

The dynamic network selection module 100 uses these inputs 101 to select one of the network protocols. In one embodiment, the dynamic network selection module 100 continuously monitors these inputs and creates a decision function. For example, the decision function may be as follows:

$$f = {α}_{1} * \frac{1}{P} + {α}_{2} * \frac{1}{B} + {α}_{3} * W + {α}_{4} * I - {α}_{5} * S e c$$

wherein α₁, α₂, α₃, α₄, and α₅ are system defined weights that are unique for each supported network protocol. These weights may be determined using a machine learning module, as described below. For this decision function, the network protocol with the associated weights that returns the smallest value may be the network of choice. In another embodiment, a maximum value may be used to determine the network of choice. This may depend on the selection of the weights.

If the dynamic network selection module 100 determines that the network of choice is different from the network protocol currently being used, the dynamic network selection module 100 needs to initiate a handoff from the currently used network to the newly determined network of choice. In one embodiment, the dynamic network selection module 100 may utilize a handoff module 140 to make this transition. The handoff module 140 is responsible for re-encrypting the communication channel and re-authenticating the location credentials. Further, the handoff module 140 may be responsible for notifying external devices of the new channel parameters. Specifically, the handoff module 140 coordinates a multi-step transition process whenever the network device 10 switches from one protocol to another. A typical handoff may include the following phases:

### 1. Channel Coordination:

The handoff module 140 queries the newly selected network stack (which may be the first network stack 110, the second network stack 120 or the third network stack 130) to establish preliminary link parameters (such as frequency channel, transmit power, etc.).
These parameters are then stored internally and marked as “pending” for activation once authentication/encryption is established.

### 2. Security Re-Keying and Authentication:

The handoff module 140 either generates new ephemeral keys or retrieves pre-shared keys (PSKs) from secure storage to be used with the new network stack.
If location credentials (e.g., shared keys or certificates used by anchor devices) are required, the handoff module 140 re-validates or re-establishes these credentials to ensure location data remains private and accurate.

### 3. Notification of External Devices (Optional):

Before fully deactivating the current connection, the handoff module 140 may broadcast a short message to nearby network neighbors (using the current network protocol) indicating that subsequent communications will move to a new channel/protocol.
This helps any listening devices or networks (e.g., mesh nodes) update their routing tables or handshake parameters accordingly.

### 4. Activation of New Link and Deactivation of Current Link:

Once the new link is confirmed and secure, the current protocol stack is gracefully powered down or set to idle mode to save energy.
In certain embodiments, both protocols may briefly run in parallel to ensure seamless connectivity. The handoff module 140 then finalizes the switch by marking the new protocol as “active.”

This procedure ensures minimal interruption, secure transitions, and updated knowledge across the local network regarding the device's new communication parameters.

Note that at initialization, the handoff module 140 is not invoked. Rather the dynamic network selection module 100 simply determines the network of choice and enables that network stack.

In certain embodiments, the dynamic network selection module 100 may rely more heavily on the projected battery level to determine the appropriate network of choice. For example, the predicted battery power (B_{pred}(t+Δt)) may be described as follows:

$${B}_{pred} ( t + Δ t ) = B ( t ) - {P}_{c o m m} ( Δ t ) - {P}_{loc} ( Δ t )$$

wherein B(t) is the current battery level, P_{comm} is the power consumed by the network protocol and P_{loc} is the power consumed by the location detection algorithm. If the predicted battery level is below a predetermined threshold, the dynamic network selection module 100 may switch to a low power network protocol, such as that associated with the third network stack 130 or a low frequency version of the network protocol associated with the first network stack 110. In other embodiments, the predicted battery power may be determined based only on the power consumed by the network protocol. Otherwise, the dynamic network selection module 100 may use the decision function identified above.

In certain embodiments, the dynamic network selection module 100 may use other information to select the network of choice. One such criteria may be whether the network device 10 is indoors or outdoors. Determining whether a device is indoors or outdoors may be done using several approaches, and the choice may vary based on system capabilities:

### 1. RSSI or Signal Pattern Analysis:

Certain known anchor devices (such as Wi-Fi or BLE beacons) have characteristic signal strengths for patterns indoors. If the network device 10 detects a stable set of indoor beacons or very limited GPS signal, it may infer an indoor environment.
Sudden changes in multipath or interference patterns may also be indicative of moving from indoors to outdoors (or vice versa).

### 2. Ambient Sensor Data:

Some network devices may include light sensors, barometric sensors, or other environment sensors. A shift in ambient light levels or air pressure changes may suggest an outdoor vs. indoor transition.

### 3. Presence or Absence of GPS:

If the network device 10 has GPS capabilities and obtains a reliable fix, that often indicates an outdoor environment.
If GPS is consistently unavailable, it may imply the network device is indoors.

### 4. User or System Configuration:

In fixed installations, the network device 10 may be pre-labeled as “indoor” or “outdoor.”
Alternatively, a central management system might know that a set of mesh nodes is located inside a building.

### 5. Available Network Clues:

If the network device can only detect mesh nodes (Thread/Zigbee) or BLE beacons typical of indoor scenarios, the software may infer an indoor environment.
Conversely, if the network device 10 detects sub-GHz signals that are typically used for wide-area coverage (like LoRa or certain FSK signals), it may infer it is outdoors.

Any combination of these heuristics or sensor readings can be fed into the dynamic network selection module 100 to automatically classify the environment.

As an example, if the network device 10 determined that it is indoors, the dynamic network selection module 100 may select the network protocol associated with the first network stack 110 or the second network stack 120. However, if the network device 10 is outdoors, the dynamic network selection module 100 may select the network protocol associated with the third network stack 130.

Similarly, if the network device 10 is able to communicate with other devices using the second network stack 120 (i.e. the mesh network), the dynamic network selection module 100 may elect to utilize the second network protocol. However, if it cannot communicate with other devices using the mesh network, the dynamic network selection module 100 may elect the third network stack 130, which may be a sub-GHz band network.

As noted above, the weights used in the decision function may be determined by a machine learning model. This machine learning model may use the same inputs as are used by the dynamic network selection module 100. In addition, the machine learning model may also include the history of handoffs, as this may be indicative of incorrect decisions. The machine learning model, which may be a regression or classification model, may be trained using historical data and iteratively adjusted.

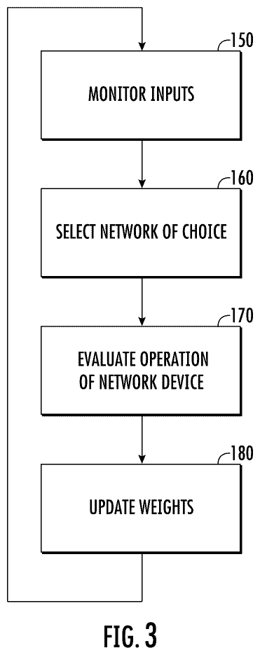

FIG. 3 shows the operation of the machine learning model according to one embodiment. As shown in Box 150, the machine learning model monitors the inputs. As described above, these inputs include proximity (P) to the nearest external anchor device (for location detection), the current battery level (B), the bandwidth/latency requirements (W) associated with the current communications, the measured or estimated interference (I) from the environment and the security requirements (Sec). Additionally, the machine learning model may also monitor historical handoff outcomes. Next, as shown in Box 160, the machine learning model decides, based on these parameters, the network of choice. Next, as shown in Box 170, the machine learning model evaluates these decisions. Specifically, the machine learning model observes whether each decision led to a stable connection, minimal power use or reduced number of handoffs. These metrics are used to provide a “success” or “cost” value for each decision. Then, based on the compute resources available, either the network device 10 or an external device executes a supervised or reinforcement learning algorithm that maps the inputs to the ideal network protocol. Based on this analysis, the weights used in the decision function are updated to minimize the observed cost or maximize stability, as shown in Box 180. This process then repeats, with the machine learning model using the updated weights.

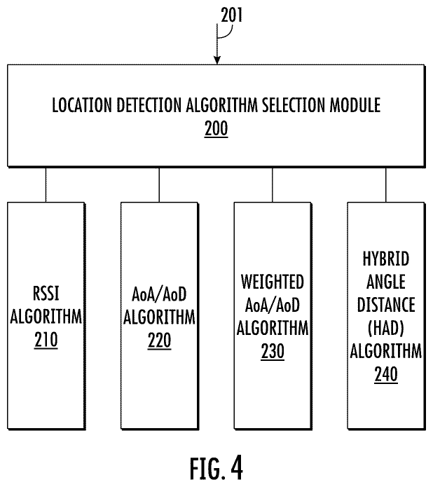

FIG. 4 shows the software associated with the selection of the location detection algorithm. This software may be referred to as the location detection algorithm selection software. This software includes a location detection algorithm selection module 200. This module is responsible for determining the location detection algorithm that should be used based on various inputs 201. These inputs 201 may include the proximity to the nearest anchor device (P), the battery level (B) of the network device 10, the measured or estimated interference (I) from the environment, and the required accuracy requirement (AccReq). Based on these inputs 201, the location detection algorithm selection module 200 may select one of several different location detection algorithms.

For example, there may be a RSSI-based (Received Signal Strength Indication) location algorithm 210, wherein the location of the network device 10 is determined based on the RSSI (Received Signal Strength Indication) of signals received from other devices, such as location anchor devices. For example, the distance between the network device 10 and a transmitting location anchor device may be defined as:

$$d = c * {RSSI}^{β}$$

wherein c and β are environment dependent variables and RSSI is the measured RSSI. If the distance from three or more location anchor devices (each in a known location) is determined, the location of the network device 10 may be calculated. The RSSI-based location algorithm 210 may be used with any of the network protocols.

Alternatively, the location detection algorithm may be an angle of arrival (AoA)/angle of departure (AoD) algorithm 220. In this algorithm, an antenna array is used to transmit or receive a constant tone. The difference in the phase of the signal received by two different angles in the antenna array may be used to calculate the angle from which the signal was transmitted. If this procedure is performed for several transmitting anchor devices, and the locations of those transmitting anchor devices are known, the location of the network device 10 may be calculated based on the angles and the known locations of the anchor devices.

Furthermore, to improve the accuracy of the location detection, both the RSSI-based location algorithm 210 and the AoA/AOD algorithm 220 may be employed to calculate the location of the network device 10.

For example, the value of the RSSI may be used to assign a weight to each AoA/AOD measurement. This may be referred to as a weighted AoA/AOD algorithm 230. In one embodiment, weights are assigned using the following equation:

$${w}_{i} = \frac{{RSSI}_{i}}{{\sum }_{j} {RSSI}_{j}}$$

wherein the numerator is the RSSI of the signal associated with the current anchor device and the denominator is the sum of all RSSI measurements for all anchor devices that were measured.

In this way, stronger signals are given more weight than low strength signals, which may be the result of multipath.

In another embodiment, a hybrid angle distance (HAD) algorithm 240 may be used. The hybrid angle distance algorithm 240 uses multiple AoA/AOD and RSSI measurements to achieve high accuracy precision, such as precision within 10 centimeters. The algorithm operates by gathering angle and distance values from multiple anchor devices. The AoA/AOD algorithm provides the angle information, while the RSSI-based location algorithm provides distance information using the equation provided above. Thus, using all of this information, the position may be determined using the following equation:

$${min}_{X , Y} {\sum }_{i} {‖ ( X - {x}_{i} , Y - {y}_{i} ) - , {d}_{i} * ( cos {θ}_{i} , sin {θ}_{i} ) ‖}^{2}$$

wherein xᵢ, yᵢ are the cartesian coordinates of an anchor device, di is the calculated distance to that anchor device (using the RSSI algorithm) and θᵢ is the angle of arrival of the signal from that anchor device. To solve this equation, a sweep of X and Y values are used in this equation to find the minimum value. Further, the RSSI may be used to introduce weights into this equation, as described above.

Note that all of the algorithms that utilize AoA/AOD require the use of Bluetooth LE. The RSSI algorithm is operable with any network protocol. Furthermore, the RSSI-based location algorithm 210 may consume less power than the other algorithms.

Thus, as shown in FIG. 4, the location detection algorithm selection module 200 uses the inputs 201 to determine whether to use the RSSI-based location algorithm 210, the AoA/AOD algorithm 220, the weighted AoA/AOD algorithm 230 or the hybrid angle distance (HAD) algorithm 240.

In one embodiment, location detection algorithm selection module 200 uses the battery level (B) and the required location accuracy requirement (AccReq) to make this determination. Specifically, if the battery level is sufficiently high and the precise location accuracy is also necessary, the location detection algorithm selection module 200 may select an algorithm that utilizes AoA/AOD, such as the weighted AoA/AOD algorithm 230 or the hybrid angle distance algorithm 240.

In certain embodiments, the location detection algorithm selection module 200 may rely on the projected battery level to determine the appropriate location detection algorithm. For example, the predicted battery power may be described as follows:

$${B}_{pred} ( t + Δ t ) = B ( t ) - {P}_{c o m m} ( Δ t ) - {P}_{loc} ( Δ t )$$

wherein B(t) is the current battery level, P_{comm} is the power consumed by the network protocol and P_{loc} is the power consumed by the location detection algorithm. If the predicted battery level is below a predetermined threshold, the location detection algorithm selection module 200 may switch to the RSSI-based location algorithm 210, or may reduce the sampling rate of the Bluetooth LE-based location detection algorithms.

In certain embodiments, other inputs may also be used by the location detection algorithm selection module 200. For example, the location detection algorithm selection module 200 may be provided information that there is a line of sight to one or more anchor devices. Line of sight detection may be informed by:

### 1. Angular Spread Measurements:

If, using angle-of-arrival (AoA) techniques, a clean, narrow angle is measured, this may indicate direct line of sight, whereas highly scattered or multipath-rich signals imply obstructions.

### 2. Ultrasonic or Infrared Sensors (If Available):

Some systems use additional short-range sensors that can confirm a direct path to the anchor device if an IR or ultrasonic signal is not obstructed.

### 3. Environmental Maps/Known Layouts:

Preloaded floor plans or environmental data may indicate whether an anchor device is physically blocked.
If a network device knows it is in a corridor vs. an open space, it may infer the likelihood of line of sight to certain anchor devices.

### 4. Signal Strength Stability/Multipath Analysis:

An anchor device with highly stable signal strength over time or consistent phase angles suggests a direct path. Excessive fluctuations typically imply reflections or obstructions.

The location detection algorithm selection module 200 can fuse one or more of these indicators to decide if line of sight is probable, which, in turn, influences the choice of AoA/AOD-based methods vs. a purely RSSI-based method.

If there is a line of sight to an anchor device, and the interference (I) from the environment is low, the location detection algorithm selection module 200 may select a Bluetooth LE-based algorithm, such as the AoA/AOD, weighted AoA/AoD or hybrid angle distance algorithms. Otherwise, the location detection algorithm selection module 200 may utilize the RSSI-based location algorithm 210.

In yet another embodiment, the location detection algorithm selection module 200 may be made aware of whether the network device 10 is indoors or outdoors. This may be done using any of the concepts described above. If the network device 10 is indoors, the location detection algorithm selection module 200 may select a Bluetooth LE-based algorithm, such as the AoA/AOD, weighted AoA/AOD or hybrid angle distance algorithms. If the network device 10 is outdoors, the location detection algorithm selection module 200 may select the RSSI-based location algorithm 210. The location detection algorithm selection module 200 may determine its location based on how it is able to connect with other devices. For example, if the network device 10 connects to other devices using the first network stack 110 or the second network stack 120, it may assume that it is indoors.

Further, the location detection algorithms may be used in conjunction with the “Find My Device” application. The “Find My Device” differs from the location detection described above in that it is the external anchor devices that perform the localization. In other words, in the location detection described above, the network device 10 uses the AoA/AOD or RSSI methods to locate itself relative to known anchor devices. In the “Find My Device” application, the external anchor devices become active participants and detect the lost device's advertisements or beacons. Using AoA/AOD or RSSI information from multiple anchor devices, the anchor devices can identify the location of the lost device and communicate that information back to the owner. Thus, the external anchor devices may use the hybrid angle distance algorithm 240 to detect the lost device's signal and measure its AoA/AOD and RSSI. Based on this, the location of the lost device may be determined, as explained above.

Note that in some embodiments, the selection of the network of choice and the location detection algorithm are connected.

For example, if the network device 10 is located indoors, the dynamic network selection module 100 may select the Bluetooth LE and the location detection algorithm selection module 200 may select an algorithm that utilizes AoA/AOD. However, if the network device is located outdoors, the dynamic network selection module 100 may select the sub-GHz network protocol and the location detection algorithm selection module 200 may select the RSSI-based location algorithm 210.

As another embodiment, if the battery level of the network device 10 is below some predetermined threshold, the dynamic network selection module 100 may select the sub-GHz network or a frequency reduced Bluetooth LE and the location detection algorithm selection module 200 may select the RSSI-based location algorithm 210.

Further, if the network of choice is not BLE, the location detection algorithm selection module 200 may select the RSSI-based location algorithm 210.

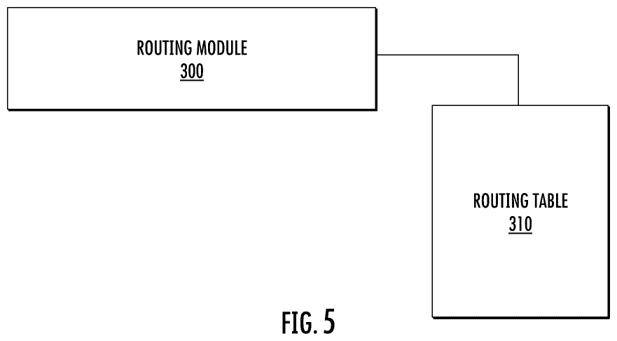

FIG. 5 shows another component of the software contained in the instructions 26, referred to as the routing software. Specifically, this routing software is concerned with routing within the mesh network, which may be the network associated with the second network stack 120.

This software includes a routing module 300, which is in communication with a routing table 310. The routing module 300 creates and maintains the routing table 310, which contains the reachable nodes in the mesh network.

For a packet destined for a destination node within the mesh network, the routing module 300 selects a path that includes one or more hops to get the packet from the network device 10 to the destination node. In some embodiments, this path may be chosen to minimize latency and power consumption.

If the packet is destined for a destination node that is not located in the routing table 310, the routing module 300 will instruct the second network stack 120 to forward the packet to the network bridge.

The network bridge, which is typically a different device such as a gateway, then selects an alternative network protocol (i.e. the first network stack 110 or the third network stack 130) using the decision function described above. The network bridge has the capability to route traffic between different protocols or bands. If the destination node is not found in the mesh (second network stack 120), the bridge node can decide to forward that (third traffic over BLE (first network stack 110) or sub-GHZ network stack 130) based on the same decision logic used by the network device's dynamic network selection module 100.

The present system has many advantages. The disclosed algorithms present a multi-protocol, machine learning-driven, and environment adaptive system that integrates BLE as both an access and a high-precision or low-power localization technology, combined with Thread and Sub-GHz communications. Key advancements include:
Dynamic, ML-driven protocol selection: Seamlessly blends Thread, Sub-GHz, and BLE communications based on real-time conditions.
Adaptive location resolution: Utilizes AoA/AOD/HADM for high accuracy when needed and falls back to RSSI-based localization to save power.
Seamless transitions: Ensures secure and uninterrupted handoffs with re-encryption and environment-aware adjustments across heterogeneous IOT networks.
Hybrid BLE usage: Employs BLE for both communication access and high-precision or low-power localization within the same integrated framework.
Power optimization: Dynamically manages power consumption by selecting appropriate communication.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A network device capable of operating using at least three different network protocols, comprising:
a network interface;
a processing unit; and
a memory device in communication with the processing unit, comprising instructions executable by the processing unit, the instructions comprising:
a first network stack to support a first network protocol;
a second network stack to support a second network protocol;
a third network stack to support a third network protocol;
a dynamic network selection module to select between the at least three network protocols; and
a handoff module to manage a transition from one network protocol to another network protocol.

2. The network device of claim 1, wherein the dynamic network selection module receives one or more inputs and determines an appropriate network protocol based on the one or more inputs.

3. The network device of claim 2, wherein the one or more inputs comprise one or more of proximity (P) to a nearest external anchor device, current battery level (B), bandwidth/latency requirements (W), measured or estimated interference (I) from environment or security requirements (Sec).

4. The network device of claim 3, wherein the dynamic network selection module comprises a machine learning module that uses at least two of the one or more inputs to determine the appropriate network protocol.

5. The network device of claim 4, wherein the machine learning module utilizes a decision function having weights associated with each network protocol and each of the at least two of the one or more inputs.

6. The network device of claim 3, wherein the dynamic network selection module estimates a battery level based on a current battery level and power consumed by a current network protocol, and selects the appropriate network protocol based on the estimated battery level.

7. The network device of claim 2, wherein the dynamic network selection module selects the appropriate network protocol based on whether the network device is located indoors or outdoors.

8. The network device of claim 1, wherein the first network protocol comprises Bluetooth LE, the second network protocol comprises a mesh network protocol and the third network protocol comprises a sub-GHz network protocol.

9. The network device of claim 1, wherein when a new network protocol is selected, the handoff module queries a newly selected network stack to establish parameters for a new link, performs security re-keying and authentication, and activates the new link and deactivates a current link.

10. A network device capable of utilizing at least two different location detection algorithms, comprising:
a network interface;
a processing unit; and
a memory device in communication with the processing unit, comprising instructions executable by the processing unit, the instructions comprising:
a RSSI-based location algorithm;
at least one angle of arrival (AoA)/angle of departure (AoD) based location algorithm; and
a location detection algorithm selection module to select between the RSSI-based location algorithm and the at least one AoA/AOD based location algorithm.

11. The network device of claim 10, wherein one of the at least one AoA/AOD based location algorithm, referred to as a weighted AoA/AOD algorithm, uses RSSI information to assign a weight to various AoA/AOD measurements.

12. The network device of claim 10, wherein one of the at least one AoA/AOD based location algorithm, referred to as a hybrid angle distance (HAD) algorithm, uses AoA/AOD information and RSSI information from a plurality of external anchor devices to determine a distance and angle to each of the plurality of external anchor devices and uses the distance and angle to determine a location of the network device.

13. The network device of claim 12, wherein the RSSI information is also used to assign a weight to information associated with each of the plurality of external anchor devices.

14. The network device of claim 10, wherein the location detection algorithm selection module selects a location detection algorithm based on whether the network device is located indoors or outdoors.

15. The network device of claim 10, wherein the location detection algorithm selection module estimates a battery level based on a current battery level and power consumed by a current network protocol, and selects a location detection algorithm based on an estimated battery level.

16. The network device of claim 10, wherein the location detection algorithm selection module selects a location detection algorithm based on whether there is a line of sight to at least one external anchor device.

17. The network device of claim 10, wherein the location detection algorithm selection module selects a location detection algorithm based on a network protocol currently being used by the network device.

18. A system that utilizes a mesh network, comprising:
a plurality of network devices; and
a network bridge;
wherein each of the plurality of network devices maintains a routing table for reachable network devices in the mesh network;
wherein if a packet is intended for a network device that is not in the routing table, the network device forwards the packet to the network bridge; and
wherein the network bridge uses one or more inputs to determine whether to forward the packet using a sub-GHz network or Bluetooth LE.

19. The system of claim 18, wherein the one or more inputs comprise proximity (P) to a nearest external anchor device, current battery level (B), bandwidth/latency requirements (W), measured or estimated interference (I) from environment or security requirements (Sec).

20. The system of claim 19, wherein the network bridge comprises a machine learning module that uses at least two of the one or more inputs to select the sub-GHz network or Bluetooth LE.
